(19) United States
(12) Patent Application Publication
(10) Pub. No.: US 2016/0027004 A1
(43) Pub. Date: Jan. 28, 2016

(54) INFORMATION PROCESSING SYSTEM, INFORMATION PROCESSING APPARATUS, MOBILE TERMINAL APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Tatsuya SUZUKI, Kanagawa (JP)

(73) Assignee: FUJI XEROX CO., LTD., Tokyo (JP)

(21) Appl. No.: 14/597,713

(22) Filed: Jan. 15, 2015

(30) Foreign Application Priority Data
Jul. 22, 2014 (JP) 2014-148462

(51) Int. Cl. G06Q 20/38; G06Q 20/40; G06Q 30/04; H04L 29/06; H04W 12/04

(52) U.S. Cl. CPC G06Q 20/382; H04L 63/0435; H04L 63/0492; H04W 12/04; G06Q 30/04; G06Q 20/401

(57) ABSTRACT

An information processing system includes a mobile terminal apparatus and an information processing apparatus. The information processing apparatus includes an encryption unit encrypting multiple pieces of data to be transmitted; a data transmission processing unit executing a transmission process to sequentially transmit the pieces of encrypted data to the mobile terminal apparatus in response to a request; a billing unit submitting a bill for each piece of transmitted data after the piece of data is transmitted; and a decryption information transmitting unit transmitting decryption information on decryption of the data for which payment of a charge with electronic money is confirmed to the mobile terminal apparatus. The mobile terminal apparatus includes a data receiving unit receiving the pieces of data; a decryption information receiving unit receiving the decryption information; and a decryption unit decrypting each piece of received data based on the received decryption information.

### CROSS-REFERENCE TO RELATED APPLICATIONS

This application is based on and claims priority under 35 USC 119 from Japanese Patent Application No. 2014-148462 filed Jul. 22, 2014.

### BACKGROUND

(i) Technical Field

The present invention relates to an information processing system, an information processing apparatus, a mobile terminal apparatus, an information processing method, and a non-transitory computer readable medium.

(ii) Related Art

Convenience stores exist which provide scanning services in which users are caused to scan documents that are brought into the stores using multifunction machines in the stores and the scan data is transferred to mobile terminals (for example, smartphones) that are Wi-Fi connected and that are carried by the users.

Electronic money is one payment method used by the users of the scanning services. The users who have selected the payment using the electronic money set integrated circuit (IC) cards having the electronic money recorded thereon in certain card readers. Service charges are deducted from the IC cards after the scan data is written onto external storage apparatuses of the users.

### SUMMARY

According to an aspect of the invention, there is provided an information processing system including a mobile terminal apparatus and an information processing apparatus to which the mobile terminal apparatus is connectable. The information processing apparatus includes an encryption unit that encrypts multiple pieces of data to be transmitted; a data transmission processing unit that executes a transmission process to sequentially transmit the pieces of data encrypted by the encryption unit to the mobile terminal apparatus in response to a request from the mobile terminal apparatus; a billing unit that submits a bill for each piece of data transmitted by the data transmission processing unit after the piece of data is transmitted; and a decryption information transmitting unit that transmits decryption information on decryption of the data for which payment of a charge with electronic money is confirmed by the billing unit to the mobile terminal apparatus. The mobile terminal apparatus includes a data receiving unit that receives the pieces of data transmitted from the information processing apparatus; a decryption information receiving unit that receives the decryption information transmitted from the information processing apparatus; and a decryption unit that decrypts each piece of data received by the data receiving unit based on the decryption information received by the decryption information receiving unit.

### BRIEF DESCRIPTION OF THE DRAWINGS

Exemplary embodiments of the present invention will be described in detail based on the following figures, wherein:

FIG. 1 is a block diagram illustrating an exemplary configuration of an information processing system according to a first exemplary embodiment of the present invention;

FIG. 2 illustrates an exemplary hardware configuration of a multifunction machine in the first exemplary embodiment;

FIG. 3 illustrates an exemplary hardware configuration of a computer installed in a mobile terminal in the first exemplary embodiment;

FIG. 4A is a flowchart illustrating an exemplary operational process to transfer scan data in the first exemplary embodiment;

FIG. 4B is a flowchart illustrating the exemplary operational process to transfer scan data, which follows the flowchart in FIG. 4A;

FIG. 5 illustrates an exemplary progress display screen displayed in the mobile terminal during file transfer in the first exemplary embodiment;

FIGS. 6A and 6B illustrate exemplary screens displayed in the mobile terminal after the file transfer is finished in the first exemplary embodiment;

FIG. 7 is a flowchart illustrating an exemplary recovery process executed when a problem occurs in the process to transfer the scan data in the first exemplary embodiment;

FIGS. 8A and 8B illustrate exemplary screens displayed in the mobile terminal in the recovery process in the first exemplary embodiment; and

FIG. 9 illustrates an example of the entire configuration of an information processing system according to a second exemplary embodiment of the present invention.

### DETAILED DESCRIPTION

Exemplary embodiments of the present invention will herein be described with reference to the attached drawings.

### First Exemplary Embodiment

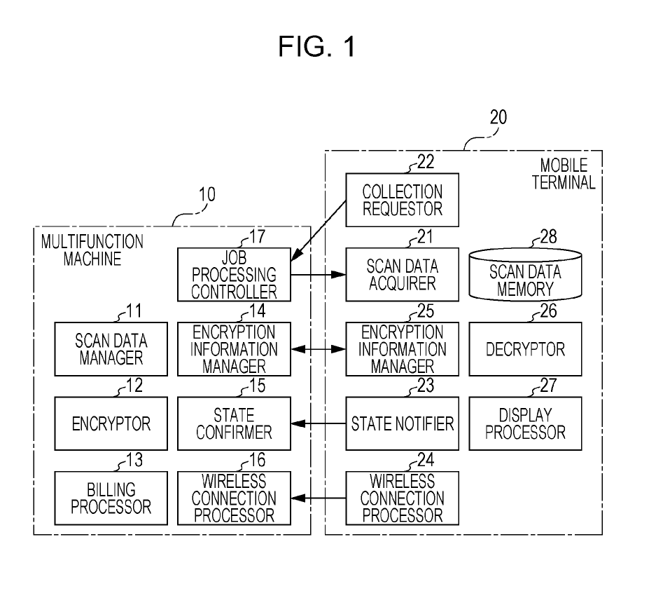

FIG. 1 is a block diagram illustrating an exemplary configuration of an information processing system according to a first exemplary embodiment of the present invention.

Referring to FIG. 1, the information processing system includes a multifunction machine 10 and a mobile terminal 20. The multifunction machine 10 is an information processing apparatus that is placed in a store, such as a convenience store, and that provides various services including a scanning service and a printing service to customers. Although the information processing apparatus is incorporated in the multifunction machine 10 in the first exemplary embodiment, a digital front end (DFE) corresponding to the information processing apparatus and a multifunction machine that includes a scanner, a print engine, etc. to provide various functions may be separately provided. The mobile terminal 20 is a mobile terminal apparatus carried by a customer (hereinafter referred to as a “user”) and is, for example, a smartphone or a tablet terminal.

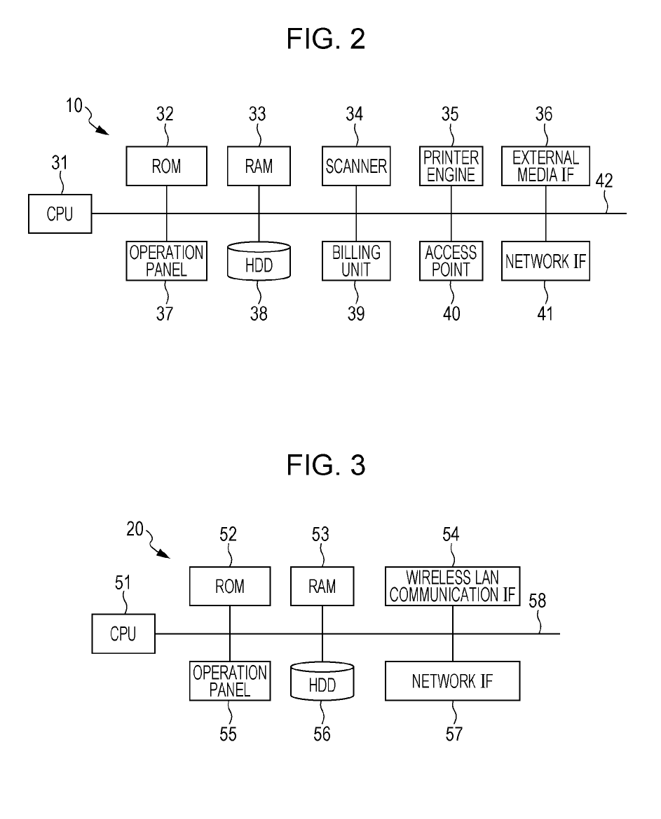

FIG. 2 illustrates an exemplary hardware configuration of the multifunction machine 10 in the first exemplary embodiment. The multifunction machine 10 has various functions including a copy function and a scanner function and includes a computer. Referring to FIG. 2, the multifunction machine 10 includes a central processing unit (CPU) 31, a read only memory (ROM) 32, a random access memory (RAM) 33, a scanner 34, a printer engine 35, an external media interface (IF) 36, an operation panel 37, a hard disk drive (HDD) 38, a billing unit 39, an access point 40, a network interface (IF) 41, and an address data bus 42. The CPU 31 controls the operations of the various mechanisms, such as the scanner 34 and the printer engine 35, mounted in the multifunction machine 10 in accordance with programs stored in the ROM 32. The ROM 32 stores the various programs concerning the control of the multifunction machine 10, encryption of electronic data, and transmission and reception of the electronic data. The RAM 33 is used as a working memory in the execution of the programs and a communication buffer in the transmission and reception of the electronic data. The scanner 34 scans a document set by the user and stores the result of the scanning as the electronic data in, for example, the HDD 38. The printer engine 35 prints out an image on a sheet in accordance with an instruction from a control program executed by the CPU 31. The external media interface 36 is an interface with an external memory device, such as a universal serial bus (USB) memory. The operation panel 37 is a user interface unit that receives an instruction from the user to display information. The HDD 38 stores digital data, such as the image scanned by the scanner 34. The billing unit 39 is used for billing the user for each service provided by the multifunction machine 10. The access point 40 performs wireless local area network (LAN) communication with a wireless LAN client (the mobile terminal 20 in the first exemplary embodiment) via Wireless Fidelity (Wi-Fi). In the first exemplary embodiment, connection between the access point 40 and the wireless LAN client according to a Wi-Fi wireless LAN standard so as to be capable of communication via a network is referred to as “Wi-Fi connection.” Disconnection of the Wi-Fi network connection is referred to as disconnection of the Wi-Fi connection. The network interface 41 is connected to a network, such as the Internet, with a communication method other than Wi-Fi to be used for, for example, communication with a file server placed in a management center. The various mechanisms controlled by the CPU 31 are connected to the address data bus 42 to perform data communication.

FIG. 3 illustrates an exemplary hardware configuration of a computer installed in the mobile terminal 20 in the first exemplary embodiment. The mobile terminal 20 in related art may be used as the mobile terminal 20 in the first exemplary embodiment. In other words, the computer installed in the mobile terminal 20 is capable of being realized with a general hardware configuration in the related art. Referring to FIG. 3, the computer includes a CPU 51, a ROM 52, a RAM 53, a wireless LAN communication interface (IF) 54, an operation panel 55, an HDD 56, a network interface (IF) 57, and a bus 58. The wireless LAN communication interface 54 realizes the Wi-Fi wireless communication. The operation panel 55 receives an instruction from the user to display information. The network interface 57 performs network communication with external apparatuses with a communication method other than Wi-Fi. The components in the computer are connected to the bus 58.

Each of the multifunction machine 10 and the mobile terminal 20 described above is capable of being realized by the hardware configuration in the related art and the hardware configurations illustrated in FIG. 2 and FIG. 3 are only examples. The first exemplary embodiment is characterized in that the operations are controlled with the programs executed by the CPU 31 and the CPU 51.

Referring back to FIG. 1, the multifunction machine 10 includes a scan data manager 11, an encryptor 12, a billing processor 13, an encryption information manager 14, a state confirmer 15, a wireless connection processor 16, and a job processing controller 17. Components that are not used for the description in the first exemplary embodiment are omitted herein. The scan data manager 11 manages scan data. For example, the scan data manager 11 stores the scan data to be transmitted in the RAM 33 or the HDD 38 or reads out the scan data to be transmitted from the RAM 33 or the HDD 38 in response to a request. The scan data manager 11 also stores and manages the scan data encrypted by the encryptor 12. The encryptor 12, which is provided as an encryption unit, encrypts the scan data to be transmitted. The billing processor 13 performs a billing process of, for example, billing the user for each service provided by the multifunction machine 10 or collecting the charge for the service from the user. In particular, the billing processor 13, which functions as a billing unit, bills the user for the data transmitted from the job processing controller 17 each time the data has been transmitted.

The encryption information manager 14 stores and manages the scan data and an encryption key used for encryption of the transmission data. The state confirmer 15 is provided as a confirmation unit and confirms whether the mobile terminal 20 is in a state in which the mobile terminal 20 is capable of receiving the scan data and decryption information. The wireless connection processor 16 is used for the Wi-Fi connection with the mobile terminal 20 using the access point 40.

The job processing controller 17 executes a job to provide the service selected by the user in cooperation with the other components: the scan data manager 11 to the wireless connection processor 16. When the scanning service is provided in which the digital data (the scan data) on the document scanned by the scanner 34 is transmitted to the mobile terminal 20 of the user for storage, as in the first exemplary embodiment, the job processing controller 17 executes a job to transmit the scan data to the mobile terminal 20. Accordingly, the job processing controller 17 functions as a data transmission processing unit and executes a transmission process to sequentially transmit the pieces of data encrypted by the encryptor 12 to the mobile terminal 20 in response to a request from the mobile terminal 20.

Although the document is read out by the scanner 34 page by page, a data file is created for each piece of scan data corresponding to one page generated with the scanning in the first exemplary embodiment. The digital data corresponding to one page in the digital data (the scan data) generated by the readout of the document including multiple pages is hereinafter specially referred to as a “file” to discriminate between the entire digital data and the digital data corresponding to one page in the following description. In the first exemplary embodiment, the file is used as the transmission unit of the scan data and the files are sequentially transmitted by the job processing controller 17.

The components: the scan data manager 11 to the job processing controller 17 in the multifunction machine 10 are realized by cooperation of the hardware installed in the multifunction machine 10 and the programs running in the CPU 31. The RAM 33 or the HDD 38 is used as a unit that stores the data in each of the scan data manager 11 and the encryption information manager 14. Although an external storage may be used via a network, the component in the multifunction machine 10 is used for storage for security reason in the first exemplary embodiment unless otherwise specified.

The mobile terminal 20 includes a scan data acquirer 21, a collection requestor 22, a state notifier 23, a wireless connection processor 24, an encryption information manager 25, a decryptor 26, a display processor 27, and a scan data memory 28. Components that are not used for the description in the first exemplary embodiment are omitted herein. The scan data acquirer 21 functions as a data reception processing unit to receive the file transmitted from the multifunction machine 10 Wi-Fi connected to the mobile terminal 20 and store the received file in the scan data memory 28. The scan data acquirer 21 also functions as a decryption information receiving unit to receive the decryption information transmitted from the multifunction machine 10 Wi-Fi connected to the mobile terminal 20. The collection requestor 22, which is provided as a collection-request-information transmitting unit, transmits collection request information to the multifunction machine 10. The collection request information includes identification information on the data for which the payment of the charge is not confirmed with payment information in the data received with the scan data acquirer 21. The state notifier 23 notifies the multifunction machine 10 of the state of the load in the mobile terminal 20, such as the remaining capacity of the HDD 56, in response to an inquiry from the state confirmer 15. The wireless connection processor 24 is used for the Wi-Fi connection with the multifunction machine 10 using the wireless LAN communication interface 54. The encryption information manager 25 stores and manages a decryption key used for decryption of the received file. The decryptor 26, which is provided as a decryption unit, decrypts the data received by the scan data acquirer 21 on the basis of the decryption information. The display processor 27 performs a display process on the operation panel 55.

The components: the scan data acquirer 21 to the decryptor 26 in the mobile terminal 20 are realized by cooperation of the hardware installed in the mobile terminal 20 and the programs running in the CPU 51. The RAM 53 or the HDD 56 is used as a unit that stores the data in the encryption information manager 25. The scan data memory 28 is realized by the HDD 56.

The programs used in the first exemplary embodiment may be supplied by a communication unit or may be stored in a computer-readable recording medium, such as a compact disk-read only memory (CD-ROM) or a USB memory, for provision. The programs supplied from the communication unit or the recording medium are installed in the computer and the CPU in the computer sequentially executes the programs to realize the various processes.

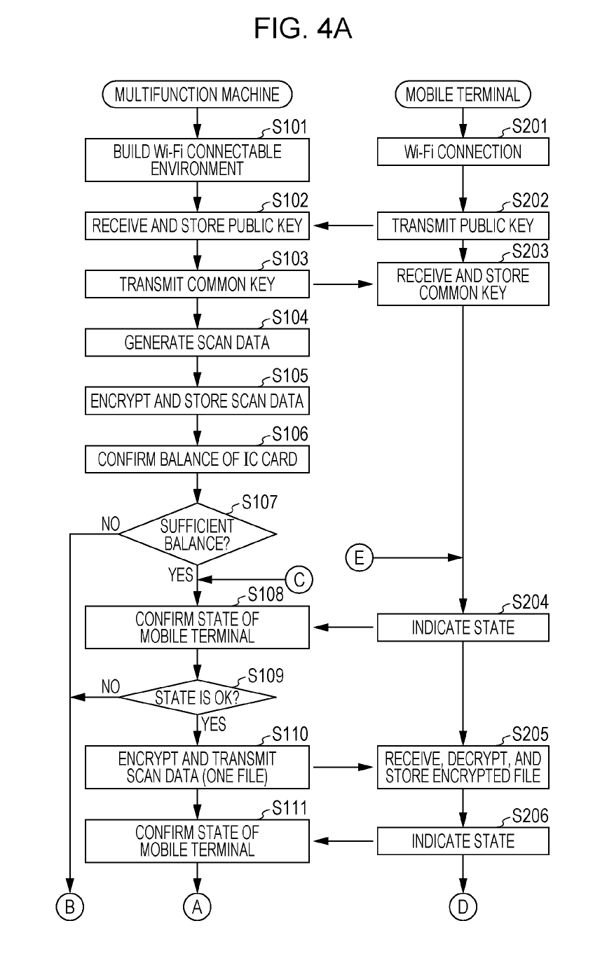

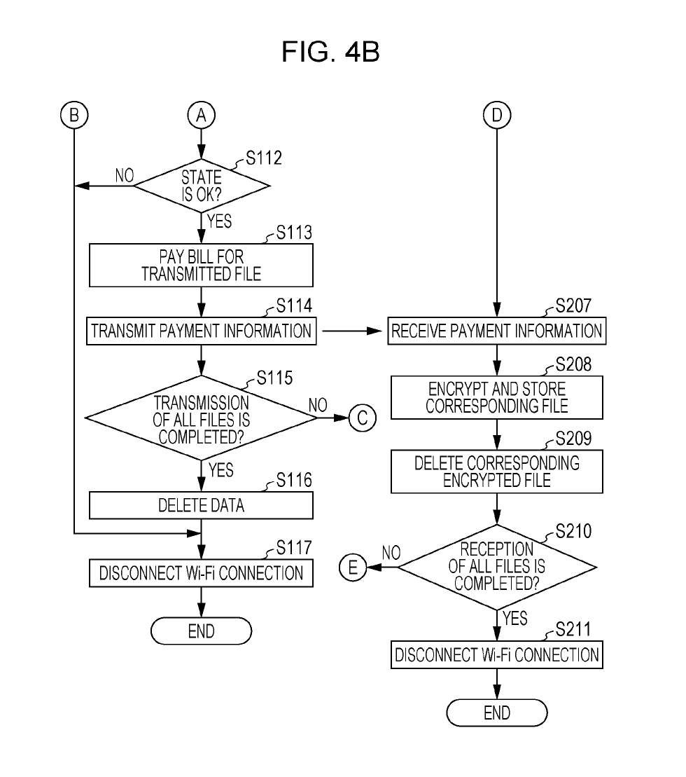

An exemplary operational process in the first exemplary embodiment will now be described with reference to FIGS. 4A and 4B. The flow of a series of processing will be described in the first exemplary embodiment, in which the user brings the mobile terminal 20 and a document into a store, such as a convenience store, and stores the digital data about the document in the mobile terminal 20 using the scanning service provided by the multifunction machine 10 placed in the store.

Referring to FIG. 4A, upon selection of the scanning service from a service menu (not illustrated) displayed on the operation panel 37 of the multifunction machine 10 by the user, in Step S101, the wireless connection processor 16 invokes the access point 40 to build a Wi-Fi connectable environment. At this time, connection to the mobile terminal 20 may be prompted on the operation panel 37.

The user who has selected the scanning service starts an application to realize the scanning service with the multifunction machine 10, which is installed in the mobile terminal 20 in advance. This activates the processing functions of the scan data acquirer 21 to the wireless connection processor 24 in the mobile terminal 20. Upon startup of the application, in Step S201, the wireless connection processor 24 in the mobile terminal 20 establishes the Wi-Fi connection with the access point 40. After selecting the scanning service, the user sets the document on a platen of the multifunction machine 10 to start the scanning. Concurrently with this, in Step S202, the encryption information manager 25 transmits a public key stored in the encryption information manager 25 to the multifunction machine 10 along with an identifier of the mobile terminal 20. A secret key composing a pair with the public key is stored in the encryption information manager 25.

Upon reception of the public key transmitted from the mobile terminal 20, in Step S102, the encryption information manager 14 in the multifunction machine 10 stores the public key. In Step S103, the encryption information manager 14 transmits a common key used for encryption and decryption of the scan data stored in the encryption information manager 14 to the mobile terminal 20.

Upon reception of the common key transmitted from the multifunction machine 10, in Step S203, the encryption information manager 25 in the mobile terminal 20 stores the common key.

In Step S104, the scanner 34 scans the document in response to the operation by the user to generate the scan data. In Step S105, the encryptor 12 encrypts the scan data with the common key and stores the encrypted scan data in the scan data manager 11. Since one file is created each time one page of the document is scanned in the first exemplary embodiment, encryption files corresponding to the number of pages of the document are created. One file may be created for multiple pages, instead of the generation of one file for each page of the document.

The user who wants to make payment with the IC card sets the IC cared in a certain card reader in accordance with a message displayed on the operation panel 37 to make a state in which the charge is capable of being collected with the billing unit 39. In Step S106, the billing processor 13 calculates the amount billed corresponding to the number of scanned pages of the document and confirms whether the amount of money corresponding to the amount billed remains in the IC card (hereinafter also referred to as “the balance is sufficient”). In Step S107, it is confirmed whether the balance is sufficient. If the balance is not sufficient (NO in Step S107), in Step S117, the job processing controller 17 determines that the scanning service is not capable of being provided and causes the wireless connection processor 16 to stop the operation of the access point 40 to disconnect the Wi-Fi connection with mobile terminal 20.

If it is confirmed that the balance is sufficient and the charge of all the pages in the document is capable of being collected (YES in Step S107), in Step S108, the state confirmer 15 confirms the state of the mobile terminal 20. Specifically, the state confirmer 15 inquires of the mobile terminal 20 whether the mobile terminal 20 is in a state in which the file to be transmitted is capable of being stored. In Step S204, the state notifier 23 in the mobile terminal 20 confirms, for example, the state of the load including the remaining storage capacity in the mobile terminal 20 and notifies the multifunction machine 10 of the result of the confirmation (state information).

In Step S109, the state confirmer 15 determines whether the Wi-Fi connection is in a state in which the file is capable of being received. If the state confirmer 15 determines that the Wi-Fi connection is in the state in which the file is capable of being received (YES in Step S109) as the result of the confirmation of the state of the Wi-Fi connection from the state in the mobile terminal 20, which is acquired from the state information transmitted from the mobile terminal 20, and the normal reception of the state information, in Step S110, the job processing controller 17 acquires one encryption file from the scan data manager 11, encrypts the encryption file with the public key, and transmits the encryption file to the mobile terminal 20.

Upon reception of the transmitted file, in Step S205, the scan data acquirer 21 in the mobile terminal 20 decrypts the file with the secret key and stores the decrypted file in the scan data memory 28. In the storage of the file in the scan data memory 28, the scan data acquirer 21 adds flag information for determining whether the file is billed for or not billed for as billing information. Since the billing of the file is not confirmed at this time, a flag value indicating that the file is not billed for is set. Since the file stored in the scan data memory 28 is still encrypted with the common key, the reference to the file is not enabled without the decryption.

If the state confirmer 15 confirms that the Wi-Fi connection is not in the state in which the file is capable of being received (NO in Step S109), in Step S117, the job processing controller 17 determines that the scanning service is disabled and causes the wireless connection processor 16 to stop the operation of the access point 40 to disconnect the Wi-Fi connection with the mobile terminal 20.

In Step S111, the state confirmer 15 confirms the state of the mobile terminal 20. Step S111 may be the same as Step S108. In Step S206, the state notifier 23 in the mobile terminal 20 confirms, for example, the state of the load in the mobile terminal 20 and notifies the multifunction machine 10 of the result of the confirmation. Step S206 may be the same as Step S204.

Referring to FIG. 14B, in Step S112, the state confirmer 15 confirms whether the Wi-Fi connection is in a state in which the payment information is capable of being received. If the state confirmer 15 determines that the Wi-Fi connection is in the state in which the payment information is capable of being received (YES in Step S112) as the result of the confirmation of the state of the Wi-Fi connection from the state in the mobile terminal 20, which is acquired from the state information transmitted from the mobile terminal 20, and the normal reception of the state information, in Step S113, the billing processor 13 pays the bill by deducting the charge of the file transmitted in Step S110 from the IC card. It has been confirmed in Step S106 that the amount of money sufficient for the payment of the bill remains in the IC card. Upon confirmation of the payment of the bill by the billing processor 13, in Step S114, the job processing controller 17 adds the identification information about the file the charge for which is collected to the payment information indicating that the charge is paid to transmit the payment information to the mobile terminal 20.

In Step S207, the payment information transmitted from the multifunction machine 10 is received. In Step S208, the decryptor 26 extracts the file identified on the basis of the identification information about the file corresponding to the payment information from the scan data memory 28, decrypts the file with the common key acquired in Step S203, and stores the decrypted file in the scan data memory 28. In the storage of the file in the scan data memory 28, the billing information about the file is changed to have a flag value indicating that the file is billed for. In Step S209, the encrypted file is deleted from the scan data memory 28. As described above, in the first exemplary embodiment, the file with being encrypted is transmitted to the mobile terminal 20 and, in mobile terminal 20, the file is decrypted only after the billing of file is confirmed and the reference to the scan data corresponding to one page of the document is enabled.

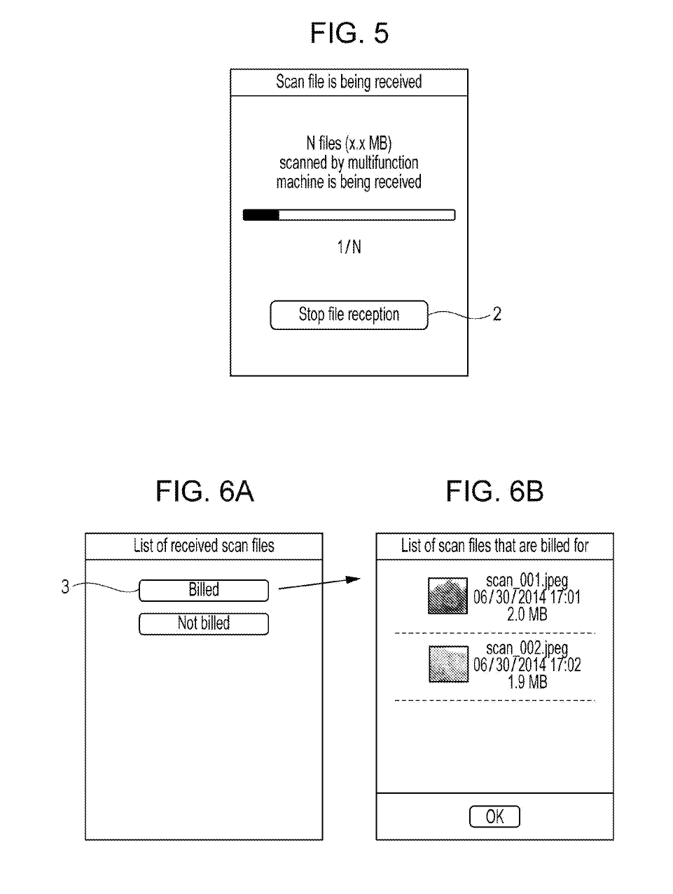

FIG. 5 illustrates an exemplary progress display screen displayed on the operation panel 55 of the mobile terminal 20 during the transfer of the scan data. The application of the mobile terminal 20 displays the progress display screen on the mobile terminal 20 to allow the user to confirm the number of pages (N) in the document and the total amount of transferred data and to confirm the progress status of the file transfer. A button 2 is provided on the progress display screen, which is used to stop the reception of the file. The application may display the progress display screen after receiving information necessary for the display of the progress display screen from the multifunction machine 10 and transmitting the public key or after receiving the common key or the first file.

The number of files that compose the scan data and that should be transmitted to the mobile terminal 20 is equal to the number of pages of the document read out by the scanner 34. Referring back to FIG. 4B, in Step S115, it is determined whether the transmission of all the files is completed. If the transmission of all the files is not completed (NO in Step S115), the process goes back to Step S108. The mobile terminal 20 has received the total number of received files in the display of the progress display screen.

Steps S108 to S114 are repeated in the multifunction machine 10 and Step S204 to S209 are repeated in the mobile terminal 20 to transmit the scan data from the multifunction machine 10 to the mobile terminal 20.

If the transmission of all the files is completed (YES in Step S115), the subsequent steps are executed in the multifunction machine 10. Specifically, in Step S116, the job processing controller 17 deletes the all the scan data stored in the scan data manager 11 and deletes the public key of the mobile terminal 20 stored in the encryption information manager 14. In Step S117, the wireless connection processor 16 stops the operation of the access point 40 to disconnect the Wi-Fi connection with the mobile terminal 20.

In Step S210, it is determined whether the reception of all the files is completed. If the reception of all the files is completed (YES in Step S210), in Step S211, the wireless connection processor 24 in the mobile terminal 20 disconnects the Wi-Fi connection with the multifunction machine 10. If the reception of all the files is not completed (NO in Step S210), the process goes back to Step S204.

FIG. 6A illustrates an exemplary screen displayed by the application of the mobile terminal 20. The screen in FIG. 6A may be automatically displayed by the display processor 27 after the use of the scanning service is finished or may be displayed in response to selection of the corresponding menu item from a menu screen (not illustrated) displayed by the application by the user. Upon selection of a “Billed” button 3 from a submenu screen illustrated in FIG. 6A for displaying a list of received pieces of scan data (files) in the document, the display processor 27 displays a list of pieces of scan data about the pages in the document, which are decrypted after confirmation of the billing, on the operation panel 55, as illustrated in FIG. 6B. Specifically, the file having the flag value indicating that the file is billed for in the billing information may be extracted for display.

Since microwaves used in the convenience stores use a 2.4-GHz frequency band supported by the smartphones, delay or interruption caused by radio wave interference is likely to occur during the data transfer. Accordingly, the Wi-Fi wireless connection is likely to be disconnected, compared with the wired connection.

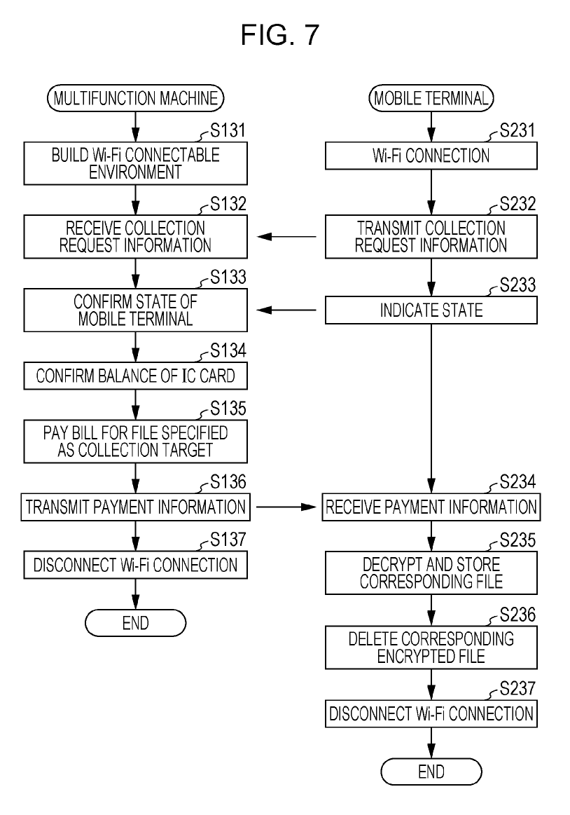

For this reason, a state may arise during the provision of the scanning service described above, in which it is not possible to transmit the payment information because, although the encryption file has been transferred, the confirmation of the state of the mobile terminal 20 in Step S112 in FIG. 4B indicates that the Wi-Fi connection is not established in the mobile terminal 20. FIG. 7 is a flowchart illustrating an exemplary recovery process when such a state arises.

The process illustrated in FIG. 7 is started upon selection of a menu item for the recovery of the scanning service from the service menu displayed in the multifunction machine 10 by the user after the provision of the scanning service is interrupted.

Referring to FIG. 7, upon selection of the scanning service to be recovered, in Step S131, the wireless connection processor 16 invokes the access point 40 to build the Wi-Fi connectable environment. At this time, connection to the mobile terminal 20 may be prompted on the operation panel 37. Upon startup of the application described above with the mobile terminal 20 by the user, in Step S231, the wireless connection processor 24 in the mobile terminal 20 establishes the Wi-Fi connection with the access point 40.

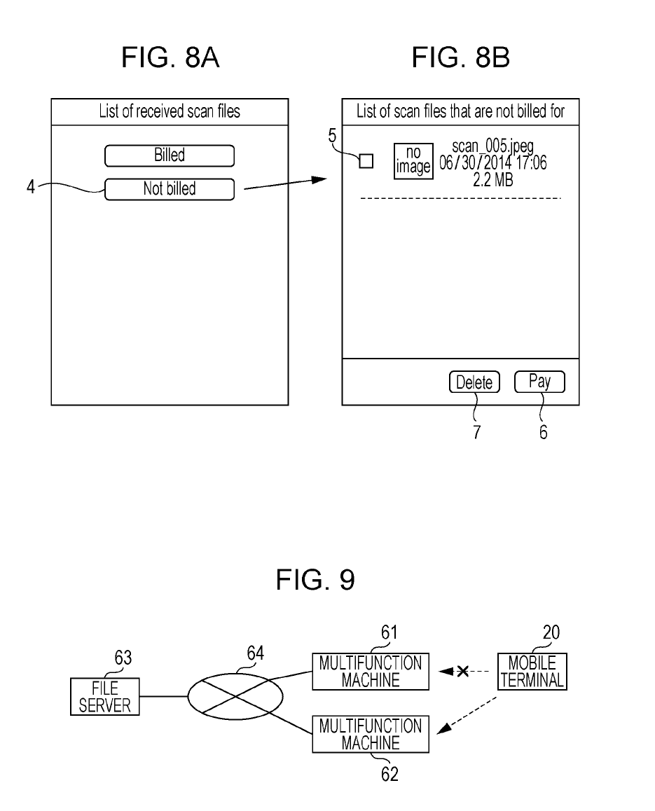

After selecting the menu item for the recovery of the scanning service, the user starts the application and performs a certain operation to display a submenu screen illustrated in FIG. 8A. This submenu screen is the same as that illustrated in FIG. 6A. Upon selection of a “Not billed” button 4 displayed on the submenu screen by the user, the display processor 27 displays a list of pieces of scan data about the pages of the document, which are not billed for, on the operation panel 55, as illustrated in FIG. 8B. The file for which the billing information indicating that the file is not billed for is set may be extracted. Since the billing is made each time one file is transmitted in the first exemplary embodiment, only the information on the scan data about one page of the document is basically displayed, as illustrated in FIG. 8B. However, in the case of the specifications in which the multiple encrypted files are collectively billed for, multiple files that are not billed for may exist. In such a case, a list of pieces of scan data about the pages of the document, which are not billed for, is displayed. Since the files are not decrypted with the common key and are still encrypted at this time, unlike the list of pieces of scan data about the pages of the document, which are billed for, no thumbnail image is displayed.

Referring back to FIG. 7, after checking a check box 5 corresponding to the file to be paid for in the list of the scan files that are displayed and that are not billed for, the user selects a “Pay” button 6. In response to this operation by the user, in Step S232, the collection requestor 22 transmits the collection request information including the information, for example, the file name, for identifying the selected file and the information indicating that the file is not billed for to the multifunction machine 10. When the user does not want the billing, the user may select a “Delete” button 7 to delete the file.

In Step S132, the job processing controller 17 receives the collection request information. In Step S133, the state confirmer 15 confirms the state of the mobile terminal 20. Step S133 may be the same as Step S108 in FIG. 4A. In Step S233, the state notifier 23 in the mobile terminal 20 notifies the multifunction machine 10 of the state information in response to an inquiry from the state confirmer 15. Step S233 may be the same as Step S204 in FIG. 4A. It is assumed here that the mobile terminal 20 has no problem.

After confirming the state of the mobile terminal 20, in Step S134, the billing processor 13 calculates the amount billed corresponding to the number of scanned pages of the document and confirms whether the amount of money corresponding to the amount billed remains in the IC card (the balance is sufficient). It is assumed here that the balance is sufficient. Since the balance of the IC card has been confirmed in Step S106 in FIG. 4A, the amount of money corresponding to the amount billed should remain in the IC card (the balance should be sufficient). In Step S135, the billing processor 13 pays the bill by deducting the charge of the file specified in the collection request information received in Step S132 from the IC card. After the payment of the bill by the billing processor 13 is confirmed, in Step S136, the job processing controller 17 adds the identification information about the file the charge for which is collected to the payment information indicating that the charge is paid to transmit the payment information to the mobile terminal 20. In Step S137, the wireless connection processor 16 stops the operation of the access point 40 to disconnect the Wi-Fi connection with the mobile terminal 20.

In Step S234, the payment information transmitted from the multifunction machine 10 is received. In Step S235, the decryptor 26 extracts the file identified on the basis of the identification information about the file corresponding to the payment information from the scan data memory 28, decrypts the file with the common key acquired in Step S203 in FIG. 4A, and stores the file in the scan data memory 28. In the storage of the file in the scan data memory 28, the billing information about the file is changed to have the flag value indicating that the file is billed for. In Step S236, the encrypted file is deleted from the scan data memory 28. In step S237, the wireless connection processor 24 in the mobile terminal 20 disconnects the Wi-Fi connection with the multifunction machine 10.

In the first exemplary embodiment, the recovery process is performed in the above manner to decrypt the encrypted file in order to allow the user to refer to the file. If the recovery process is not selected and another service is selected by the user despite the fact that the encrypted file is acquired or if another user starts to use the file, the multifunction machine 10 deletes all the pieces of scan data that are stored in the provision of the scanning service and that is encrypted, the public key, and so on. Leaving personal information (the scan data about the document in this case) in the multifunction machine 10 placed in a store, such as a convenience store, that is, in the multifunction machine 10 that is placed in a public location and is used by general public people is not desired for the customers for security. In addition, the state in which the storage is occupied by the personal information is not desired for the store.

The common key is transmitted to the mobile terminal 20 before the transmission of the encrypted file is started and the payment information is transmitted after the file is transmitted in the above description. The payment information indicates that the charge is paid and may be the flag information. The common key, instead of the payment information, may be transmitted each time the file is transmitted and the decryption key for the file may be transmitted to the mobile terminal 20. However, in the first exemplary embodiment, the common key is first transmitted only once and the flag information is subsequently transmitted in order to reduce the amount of transferred data between the multifunction machine 10 and the mobile terminal 20.

### Second Exemplary Embodiment

The multifunction machine 10 may not be capable of continuing the scanning service because the storage capacity of the mobile terminal 20 is made insufficient or the balance of the IC card is made insufficient during the provision of the scanning service and, as the result, the process may be terminated with the encrypted scan data being left in the multifunction machine 10. This situation may be addressed with the recovery process described above in the first exemplary embodiment if the cause of the interruption of the scanning service is immediately found. However, there may be a case in which the above situation is not capable of being immediately addressed. For example, the user may not have the sufficient money with him/her when the user wants to charge the IC card with the electronic money or it may take a time to store the data in the mobile terminal 20 or delete the data from the mobile terminal 20. In such a case, it is necessary for the user to scan the pages of the document again.

In a second exemplary embodiment, the above problems are addressed for the convenience of the user.

FIG. 9 illustrates an example of the entire configuration of an information processing system according to the second exemplary embodiment. Referring to FIG. 9, the information processing system includes two multifunction machines 61 and 62, the mobile terminal 20, a file server 63, and a network 64 via which the multifunction machines 61 and 62 are connected to the file server 63. The multifunction machines 61 and 62 each have the same configuration as that of the multifunction machine 10 described above in the first exemplary embodiment. Although multiple multifunction machines may access the file server 63 via the network 64, the two multifunction machines 61 and 62 are illustrated in the second exemplary embodiment for convenience. The file server 63 includes a memory that stores files. The hardware configuration and the functional configuration of each of the multifunction machines 61 and 62 and the mobile terminal 20 may be the same as those in the first exemplary embodiment except for functions described below.

It is assumed that, for example, the user of the mobile terminal 20 is using the scanning service of the multifunction machine 61 in the above configurations. It is also assumed that all the pages of the document are scanned and all the scan files have been encrypted in the multifunction machine 61. It is further assumed that the Wi-Fi connection is disconnected in the above state and the mobile terminal 20 is disabled to acquire the encrypted file. In such a situation, the job processing controller 17 in the multifunction machine 61 functions as a storage unit and terminates the process after transferring the encrypted files that have not been transmitted to the mobile terminal 20 and the identifier of the mobile terminal 20 to the file server 63 for storage.

Then, the user of the mobile terminal 20 moves to the location where the multifunction machine 62 is placed and selects a menu item for continuation of the scanning service from the service menu. The multifunction machine 61 acquires the identifier of the mobile terminal 20 from the mobile terminal 20 and makes an inquiry to the file server 63 on the basis of the identifier to acquire the encrypted file corresponding to the mobile terminal 20.

Then, the user of the mobile terminal 20 performs a certain operation to acquire the encrypted file that has not been acquired by the multifunction machine 61 from the multifunction machine 62. The common key necessary for the decryption of the encrypted files is still held by the mobile terminal 20. The public key used for the encryption when the multifunction machine 62 transmits the encrypted files may be acquired from the mobile terminal 20.

Although the process is continued in the multifunction machine 62 other than the multifunction machine 61 in which the scanning service is interrupted in the description of the second exemplary embodiment, the remaining encrypted files may be acquired from the multifunction machine 61 in which the process is interrupted.

The encrypted file is decrypted with the common key. The common key is provided by the multifunction machine 61 and not of the multifunction machine 62 in the second exemplary embodiment. However, the multifunction machine 61 transmits the common key to the mobile terminal 20 before starting the transmission of the encrypted file in the second exemplary embodiment, as described above in the first exemplary embodiment. In other words, since the mobile terminal 20 has acquired the common key from the multifunction machine 61, it is possible for the mobile terminal 20 to correctly decrypt the encrypted file even when the file to be transmitted from the multifunction machine 62 to the mobile terminal 20 is encrypted with the common key of the multifunction machine 61, as in the second exemplary embodiment.

Although how to avoid occurrences of only the collection of the charge and a refund process is described, taking the scanning service as an example, in the above exemplary embodiments, another service may be exemplified, instead of the scanning service, as long as data transmission is performed in the service.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a mobile terminal apparatus; and
an information processing apparatus to which the mobile terminal apparatus is connectable,
wherein the information processing apparatus includes
an encryption unit that encrypts a plurality of pieces of data to be transmitted;
a data transmission processing unit that executes a transmission process to sequentially transmit the pieces of data encrypted by the encryption unit to the mobile terminal apparatus in response to a request from the mobile terminal apparatus;
a billing unit that submits a bill for each piece of data transmitted by the data transmission processing unit after the piece of data is transmitted; and
a decryption information transmitting unit that transmits decryption information on decryption of the data for which payment of a charge with electronic money is confirmed by the billing unit to the mobile terminal apparatus, and
wherein the mobile terminal apparatus includes
a data receiving unit that receives the pieces of data transmitted from the information processing apparatus;
a decryption information receiving unit that receives the decryption information transmitted from the information processing apparatus; and
a decryption unit that decrypts each piece of data received by the data receiving unit based on the decryption information received by the decryption information receiving unit.

2. The information processing system according to claim 1,
wherein the decryption information includes a decryption key that is transmitted before the data is transmitted and that is commonly used for the decryption of the pieces of data and payment information that is transmitted each time the data has been transmitted and that indicates that the charge for the transmission of the data is paid, and
wherein the decryption unit decrypts the data for which the payment of the charge is confirmed with the payment information, among the pieces of data received by the data receiving unit, with the decryption key.

3. The information processing system according to claim 2,
wherein the information processing apparatus further includes a confirmation unit that confirms whether the mobile terminal apparatus is in a state in which the mobile terminal apparatus is capable of receiving the decryption information, and
wherein, if the confirmation unit confirms that the mobile terminal apparatus is not in the state in which the mobile terminal apparatus is capable of receiving the decryption information on the data after the data is transmitted by the data transmission processing unit, the billing unit stops the submission of the bill for the data and the decryption information transmitting unit stops the transmission of the decryption information on the data.

4. The information processing system according to claim 3,
wherein the information processing apparatus further includes a collection request information transmitting unit that transmits collection request information to the information processing apparatus, the collection request information including identification information on the data for which the payment of the charge is not confirmed with the payment information, among the pieces of data received by the data receiving unit,
wherein the billing unit submits the bill for data identified with the collection request information, and
wherein the decryption information transmitting unit transmits the decryption information on the data for which the bill is submitted by the billing unit.

5. The information processing system according to claim 1, comprising:
a plurality of information processing apparatuses including a first information processing apparatus and a second information processing apparatus; and
a memory,
wherein the first information processing apparatus to which the mobile terminal apparatus has been connected, among the plurality of information processing apparatuses, includes a storage unit that stores the data that has not been transmitted to the mobile terminal apparatus because of disconnection, among the pieces of data encrypted by the encryption unit, in the memory, and
wherein the second information processing apparatus to which the mobile terminal apparatus is connected, among the plurality of information processing apparatuses, acquires data stored in the memory and continues the execution of the transmission process that has been executed in the first information processing apparatus.

6. The information processing system according to claim 1,
wherein the information processing apparatus further includes a confirmation unit that confirms whether the mobile terminal apparatus is in a state in which the mobile terminal apparatus is capable of receiving the data, and
wherein the data transmission processing unit stops the transmission of the data if the confirmation unit confirms that the mobile terminal apparatus is not in the state in which the mobile terminal apparatus is capable of receiving the data.

7. An information processing apparatus comprising:
an encryption unit that encrypts a plurality of pieces of data to be transmitted;
a data transmission processing unit that executes a transmission process to sequentially transmit the pieces of data encrypted by the encryption unit to the mobile terminal apparatus in response to a request from a mobile terminal apparatus;
a billing unit that submits a bill for each piece of data transmitted by the data transmission processing unit after the piece of data is transmitted; and
a decryption information transmitting unit that transmits decryption information on decryption of the data for which payment of a charge with electronic money is confirmed by the billing unit to the mobile terminal apparatus.

8. A non-transitory computer readable medium storing a program causing a computer to execute a process comprising:
encrypting a plurality of pieces of data to be transmitted;
executing a transmission process to sequentially transmit the pieces of encrypted data to the mobile terminal apparatus in response to a request from a mobile terminal apparatus;
submitting a bill for each piece of transmitted data after the piece of data is transmitted; and
transmitting decryption information on decryption of the data for which payment of a charge with electronic money is confirmed to the mobile terminal apparatus.

9. A mobile terminal apparatus comprising:
a data receiving unit that receives pieces of encrypted data that are sequentially transmitted from an information processing apparatus in response to a request;
a decryption information receiving unit that receives decryption information concerning decryption of data for which submission of a bill is confirmed, among the pieces of data received by the data receiving unit; and
a decryption unit that decrypts each piece of data received by the data receiving unit based on the decryption information received by the decryption information receiving unit.

10. A non-transitory computer readable medium storing a program causing a computer to execute a process comprising:
receiving pieces of encrypted data that are sequentially transmitted from an information processing apparatus in response to a request;
receiving decryption information concerning decryption of data for which submission of a bill is confirmed, among the pieces of received data; and
decrypting each piece of received data based on the received decryption information.
